(19) United States
(12) Patent Application Publication
(10) Pub. No.: US 2010/0013219 A1
(43) Pub. Date: Jan. 21, 2010

(54) CONNECTION FOR HIGH-PRESSURE MEDIUM CONDUITS

(75) Inventors: Jaroslav Hlousek, Golling (AT); Volker Leifert, Stuttgart (DE); Herbert Schwaighofer, Zell am Moos (AU); Franz Guggenbichler, Kuchl (AU)

Correspondence Address: FITCH, EVEN, TABIN & FLANNERY, P. O. BOX 18415, WASHINGTON, DC, 20036, US

(73) Assignee: Robert Bosch GmbH, Stuttgart-Feuerbach (DE)

(21) Appl. No.: 11/658,586

(22) PCT Filed: Jul. 19, 2005
(86) PCT No.: PCT/AT2005/000285

§ 371 Date: Oct. 5, 2009

(30) Foreign Application Priority Data
Jul. 28, 2004 (AT) 1292/2004

(51) Int. Cl. F16L 21/035

(52) U.S. Cl. 285/341

(57) ABSTRACT

In connection for high-pressure medium conduits, in which a first conduit (1) includes a connection piece (3) inserted in the interior of a second conduit (2), wherein the connection piece (3) and the second conduit (2) carry cylindrical sealing surfaces (4, 5) cooperating with each other either directly or via an interposed seal (14), the connection piece (3), in the region of at least a portion of its sealing surface (4), is formed with a reduced wall thickness amounting to less than 50% of the wall thickness of the second conduit (2) in the region of its sealing surface (5).

The invention relates to a connection for high-pressure medium conduits, in which a first conduit includes a connection piece inserted in the interior of a second conduit, wherein the connection piece and the second conduit carry cylindrical sealing surfaces cooperating with each other either directly or via an interposed seal.

A conduit connection of this type is, for instance, required to interconnect the individual components of fuel injection systems of internal combustion engines and, in particular, diesel injection systems such as, for instance, common-rail injection systems of diesel engines. Common-rail injection systems are used in motor vehicles as well as in large-scale diesel applications for stationary engines, building machinery, farm machinery, locomotives and ships. In those cases, fuel-supplying high-pressure conduits are sealingly connected with other components of the injection system, such as, e.g. the injector of a common-rail injection system, wherein the conduits and, in particular, the connection and junction sites will have to be appropriately constructed bearing in mind the high pressures prevailing in such systems. In order to sufficiently seal connection parts having plane connection surfaces, considerable application forces are required, which must generate application pressures of up to three times the internal pressure to be sealed off. This involves high structural expenditures along with considerable space demands and high costs. In the event of cylindrical sealing surfaces, it will have to be taken care, in addition to applying axial application forces, that the mutually cooperating sealing surfaces of the connection piece between the first conduit and the second conduit in which the connection piece is inserted, will be pressed against each other in the radial direction with sufficient force such that the leakage of fluids and, in particular, fuel into the surroundings will be prevented.

The present invention aims to provide a conduit connection by which a sufficiently high sealing force is applied in the radial direction between a connection piece of a first conduit and a second conduit in which the connection piece is inserted, wherein the tightness of the conduit connection is to be safe-guarded even at internal pressures of at least 2000 bar, bearing in mind the pressures prevailing in diesel injection systems. The structural expenditures as well as the space demand for the conduit connection must, however, not exceed the usual standards, with the costs too having to be kept within acceptable limits. The conduit connection, furthermore, is to be configured so as to adapt to strongly varying internal pressures.

To solve this object, the invention essentially consists in that the connection piece, in the region of at least a portion of its sealing surface, is formed with a reduced wall thickness amounting to less than 50% of the wall thickness of the second conduit in the region of its sealing surface. Due to the fact that, in the region of the mutually cooperating sealing surfaces, the wall thickness of the inner part, i.e. the wall thickness of the connection piece inserted in the second conduit, is substantially smaller than the wall thickness of the outer part, i.e. the second conduit, it is feasible to utilize the internal pressure prevailing in the conduits to maintain tightness. Because of the smaller wall thickness, the inner part will expand more strongly than the outer part due to the internal pressure, which causes the inner part to be pressed against the outer part. The thus occurring application force is directly dependent on the prevailing internal pressure such that the respectively required application force will adjust itself automatically. It was basically noted that an inner part wall thickness amounting to less than 50% of the outer part wall thickness will do to achieve sufficient tightness even with less elastic materials. Preferred embodiments, however, result from smaller wall thicknesses for, the inner connection piece, whereby the stability of the component should, of course, not be jeopardized by wall thickness that are too thin. It is, therefore, provided in a preferred manner that the wall thickness of the connection piece in the region of at least a portion of its sealing surface is chosen to be smaller than 40%, smaller than 30%, smaller than 20%, smaller than 15%, smaller than 10%, or smaller than 5%, of the wall thickness of the second conduit in the region of its sealing surface.

The configuration is advantageously further developed such that the sealing surface of the connection piece is formed on a hollow-cylindrical extension of the connection piece, said hollow-cylindrical extension preferably having an inner diameter amounting to 70% to 95%, preferably 85% to 90%, of the inner diameter of the second conduit and preferably extending over an axial length of at least ⅓, preferably ⅓ to ⅔, of the inner diameter of the second conduit. Such dimensioning will afford optimum sealing in a diesel injection system in which, as in correspondence with a preferred configuration, the first conduit is designed as a high-pressure supply conduit for fuel and the second conduit is designed as the storage volume of an injector of a fuel injection system for an internal combustion engine, in particular diesel engine.

Enhanced sealing without jeopardizing the stability of the hollow-cylindrical extension will be provided in accordance with a preferred configuration in that the inner wall of the hollow-cylindrical extension comprises a conical clearance on the free end thereof, said conical clearance preferably forming a conical angle of 10 to 60°, preferably 30°. The increased elasticity on the site of the conical clearance will, in fact, provide an even snugger application of the hollow-cylindrical extension on the sealing surface of the second conduit.

In order to prevent the formation of a fluid cushion between the mutually cooperating sealing surfaces, which might eventually cause a leak, the configuration is advantageously further developed such that the sealing surface of the connection piece carries at least one annular groove. With a plurality of annular grooves on the sealing surface of the connection piece, an axial groove may preferably be further provided to connect said plurality of annular grooves.

If desired, an annular seal may be arranged between the mutually cooperating sealing surfaces of the connection piece and the second conduit, thus affording a configuration in which the hollow-cylindrical extension comprises a cylindrical step on its outer face, and an annular seal is arranged in the annular space formed between the sealing surface of the second conduit and the step. By the action of the internal pressure prevailing in the conduit, the annular seal is pressed against the shoulder of the cylindrical step and deformed in a manner that it too will exert a high application force on the oppositely located sealing surfaces of the connection piece and the second conduit, whereby an excellent sealing effect will be ensured. The annular seal is preferably made of a synthetic material, in particular polytetrafluoroethylene (PTFE), and rests on a metallic support ring. The annular seal may have a circular, oval, lozenge or trapezoidal cross section, whereby an enhanced application of the annular seal on the sealing surfaces will be achieved, if an annular seal having a trapezoidal cross section and an annular recess on its surface facing the interior of the second conduit is used.

In the following, the invention will be explained in more detail by way of two exemplary embodiments schematically illustrated in the drawing. Therein:

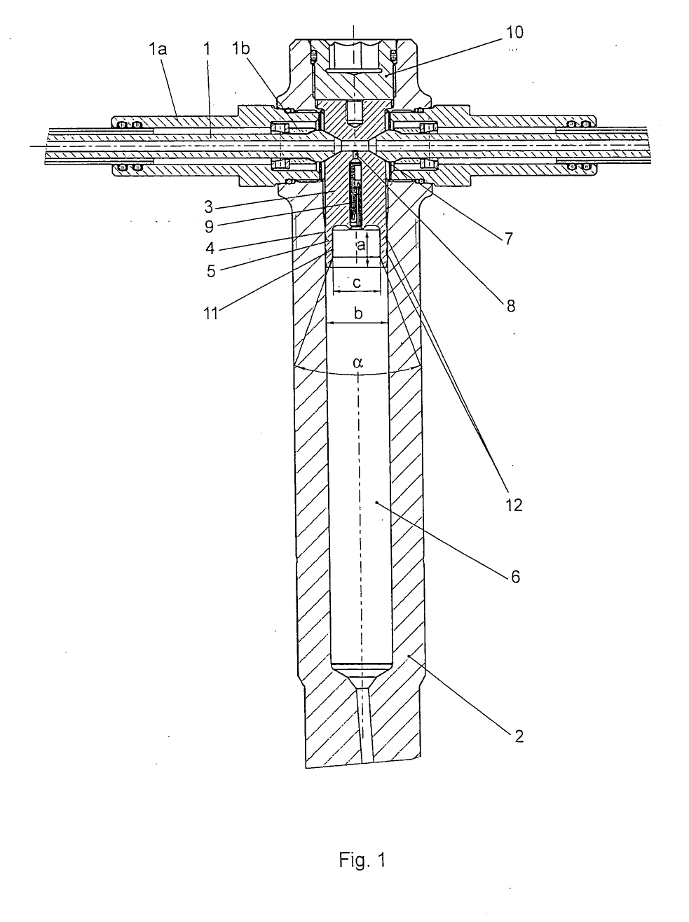

FIG. 1 depicts a first configuration of the conduit connection, and

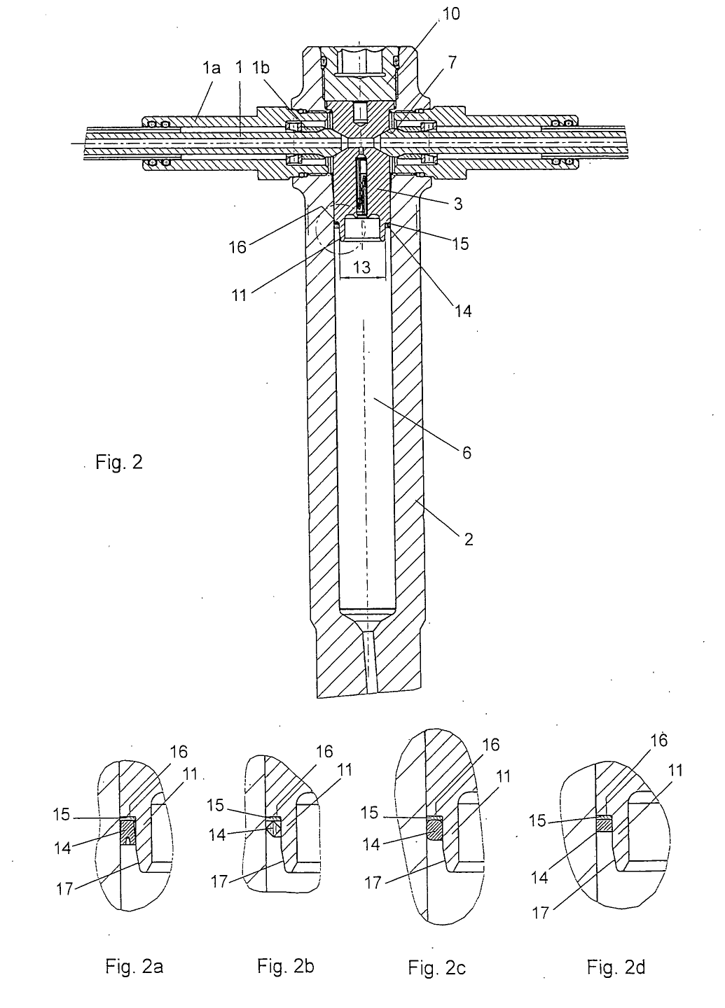

FIG. 2 depicts a second configuration of the conduit connection, according to the invention.

In FIG. 1, a first conduit 1 is connected with a second conduit 2, wherein the first conduit 1 comprises a connection piece 3 which projects into the second conduit 2. The connection piece 3 and the second conduit 2 have mutually cooperating cylindrical sealing surfaces 4 and 5, respectively. The second conduit 2 is designed as an injector body of an injector of a common-rail injection system for a diesel engine. The injector body 2 defines a storage volume 6, in which fuel is contained at a high pressure of, for instance, 2000 bar. The supply of the fuel delivered by a high-pressure pump takes place via conduits 1, which are designed as high-pressure conduits and pressed into the sealing cones 7 of the connection piece 3 via connection pieces 1b and screw connections 1a. Via a longitudinal bore 8 and a rod filter 9, the fuel reaches the storage volume 6, from which it can be injected into the combustion chamber of the engine by a magnetic-valve-controlled injection valve (not illustrated). The connection piece 3 is held in its position within the injector body 2 by a plug screw 10.

The cylindrical connection piece 3 projects deeply into the storage volume 6 designed as a cylindrical bore and comprises a hollow-cylindrical extension 11 whose length a amounts to approximately ⅓ to ⅔ of the diameter b of the storage volume 6. About the periphery of the connection piece 3 are arranged one or several annular grooves 12, which are interconnected via longitudinal grooves to pressurelessly conduct possibly leaking fuel outwardly via a connection means (not illustrated).

The diameter of the connection piece 3 is slightly smaller than, equal to, or slightly larger than, the inner diameter of the storage volume 6. This ensures simple mounting and positioning. In the event of a slightly larger diameter of the connection piece 3 as compared to the diameter of the storage volume 6, axially force-free mounting is effected by cooling of the connection piece 3 and/or heating of the injector body 2. During operation, the high fuel pressure prevailing in the storage volume 6, on account of the elastic behavior of the materials of the injector body 2 and the connection piece 3, brings about an enlargement of the diameters of both sealing partners in the region of the cylindrical sealing surfaces 4, 5. This enlargement of diameter will cause the snug application of the hollow-cylindrical extension 11 of the connection piece 3 on the inner wall of the injector body 2 because of its stronger elastic deformation on account of its reduced wall thickness. The thus occurring application force is directly dependent on the actual fuel pressure. The annular grooves 12, which are outwardly relieved without pressure, ensure that no fuel cushion will form in the sealing surface and, hence, jeopardize the tightness of the assembly.

The machining of the sealing surfaces 4, 5 of the storage volume 6 and the hollow-cylindrical extension 11 on the connection piece 3, respectively, is preferably performed in a manner that machining marks will extend radially rather than axially. The occurrence of leakages will thus be effectively avoided.

On the end of the hollow-cylindrical extension 11 facing the storage volume 6, a conical clearance forming the conical angle α may, moreover, be provided to further increase the application pressure due to the increased elasticity provided on this site.

In the arrangement according to the invention, the plug screw 10 merely needs to apply an axial force that is slightly higher than the force resulting as a product from the cross-sectional area of the storage volume 6 and the fuel pressure.

FIG. 2 likewise depicts a longitudinal section through an injector of a common-rail injection system for a diesel engine. The connection piece 3 comprises a cylindrical step 13 on its storage-volume-side end. Slipped over this step 13 is an annular synthetic element 14 which abuts on the shoulder 16 via a metallic support ring 15. Due to the action of the fuel pressure prevailing in the storage volume 6, the synthetic element 14 is pressed against the support ring 15 and the shoulder 16. It is thus deformed in a manner that it will also exert a high application force on the inner wall of the storage volume 6 and on the step 13 of the connection piece 3. This will provide an excellent sealing effect.

The cross-sectional shape of the annular synthetic element 14 can be square or rectangular. In a preferred manner, also round, oval, lozenge or trapezoidal cross sections are feasible, as are partially illustrated in FIGS. 2a, 2b, 2c and 2d. A recess in the trapezoidal cross section of the synthetic element 14 according to FIG. 2a will further enhance the application pressure on the side walls. The mounting of the support ring and the annular synthetic element can be assisted by a conical extension 17. Polytetrafluoroethylene (PTFE) is particularly suited as a material for the synthetic element 14.

The illustrated assemblies are not limited to common-rail system components, but generally applicable for connections of containers, tubes and fittings exposed to high fluid pressures.

1. A connection for high-pressure medium conduits, in which a first conduit (1) includes a connection piece (3) inserted in the interior of a second conduit (2), wherein the connection piece (3) and the inner wall of the second conduit (2) carry cylindrical sealing surfaces (4 and 5, respectively) cooperating with each other either directly or via an interposed seal (14), characterized in that the connection piece (3), in the region of at least a portion of its sealing surface (4), is formed with a reduced wall thickness amounting to less than 50% of the wall thickness of the second conduit (2) in the region of its sealing surface (5).

2. A connection according to claim 1, characterized in that the wall thickness of the connection piece (3) in the region of at least a portion of its sealing surface (4) amounts to less than 40%, preferably less than 30%, in a particularly preferred manner less than 20%, of the wall thickness of the second conduit (2) in the region of its sealing surface (5).

3. A connection according to claim 1, characterized in that the wall thickness of the connection piece (3) in the region of at least a portion of its sealing surface (4) amounts to less than 15%, of the wall thickness of the second conduit (2) in the region of its sealing surface (5).

4. A connection according to claim 1, characterized in that the sealing surface (4) of the connection piece (3) is formed on a hollow-cylindrical extension (11) of the connection piece (3).

5. A connection according to claim 4, characterized in that the hollow-cylindrical extension (11) has an inner diameter (c) amounting to 70% to 95% of the inner diameter (b) of the second conduit (2).

6. A connection according to claim 4, characterized in that the inner wall of the hollow-cylindrical extension (11) comprises a conical clearance on the free end thereof.

7. A connection according to claim 6, characterized in that the conical clearance is formed with a conical angle (α) of 10° to 60°.

8. A connection according to claim 1, characterized in that the sealing surface (4) of the connection piece (3) carries at least one annular groove (12).

9. A connection according to claim 1, characterized in that the sealing surface (4) of the connection piece (3) carries a plurality of annular grooves (12), which are interconnected by at least one axial groove.

10. A connection according to claim 1, characterized in that the hollow-cylindrical extension (11) extends over an axial length (a) of at least ⅓, of the inner diameter (b) of the second conduit (2).

11. A connection according to claim 1, characterized in that the hollow-cylindrical extension (11) comprises a cylindrical step (13) on its outer face, and an annular seal (14) is arranged in the annular space formed between the sealing surface (5) of the second conduit (2) and the step (13).

12. A connection according to claim 11, characterized in that the annular seal (14) is made of synthetic material, in particular polytetrafluoroethylene (PTEE), and rests on a metallic support ring (15).

13. A connection according to claim 11, characterized in that the annular seal (14) has a circular, oval, lozenge or trapezoidal cross section.

14. A connection according to claim 13, characterized in that the annular seal (14) formed with a trapezoidal cross section has an annular recess on its surface facing the interior of the second conduit (2).

15. A connection according to claim 1, characterized in that the first conduit (1) is designed as a high-pressure supply conduit for fuel, or as a connection piece (13) for a high-pressure supply conduit, and the second conduit (2) is designed as the storage volume of an injector of a fuel injection system for an internal combustion engine, in particular diesel engine.

16. A connection according to claim 2, characterized in that the wall thickness of the connection piece (3) in the region of at least a portion of its sealing surface (4) amounts to less than 15% of the wall thickness of the second conduit (2) in the region of its sealing surface (5).

17. A connection according to claim 2, characterized in that the sealing surface (4) of the connection piece (3) is formed on a hollow-cylindrical extension (11) of the connection piece (3).

18. A connection according to claim 3, characterized in that the sealing surface (4) of the connection piece (3) is formed on a hollow-cylindrical extension (11) of the connection piece (3).

19. A connection according to claim 5, characterized in that the inner wall of the hollow-cylindrical extension (11) comprises a conical clearance on the free end thereof.

20. A connection according to claim 12, characterized in that the annular seal (14) has a circular, oval, lozenge or trapezoidal cross section.
